(19) United States
(12) Patent Application Publication
(10) Pub. No.: US 2024/0405423 A1
(43) Pub. Date: Dec. 5, 2024

(54) DIRECTIONAL ANTENNA DEVICE AND EXTERNAL ANTENNA THEREOF

(71) Applicant: ASUSTeK COMPUTER INC., Taipei (TW)

(72) Inventors: Jo-Fan CHANG, Taipei (TW); Yu CHEN, Taipei (TW)

(21) Appl. No.: 18/526,108

(22) Filed: Dec. 1, 2023

(30) Foreign Application Priority Data
May 29, 2023 (TW) 112205400

(51) Int. Cl. H01Q 3/24; H01Q 1/22; H01Q 9/04

(52) U.S. Cl. CPC H01Q 3/247; H01Q 1/2266; H01Q 9/0407

(57) ABSTRACT

A directional antenna device and an external antenna thereof are provided. The directional antenna device includes a dielectric substrate, an antenna body, a first metal element, and a second metal element. The antenna body is located on the dielectric substrate. The first metal element is located on the dielectric substrate and on one side of the antenna body. The first metal element is in a direction opposite to a radiation direction and has a first length. The second metal element is located on the dielectric substrate and on an other side of the antenna body. The second metal element is in the same direction as the radiation direction and has a second length, and the second length is less than the first length. The first metal element and the second metal element with different lengths are used to adjust the radiation direction of the antenna as a directional antenna.

### CROSS-REFERENCE TO RELATED APPLICATION

This application claims the priority benefit of Taiwan application serial No. 112205400, filed on May 29, 2023. The entirety of the above-mentioned patent application is hereby incorporated by reference herein and made a part of the specification.

### BACKGROUND OF THE INVENTION

### Field of the Invention

The disclosure relates to a directional antenna device with adjustable focused beams and an external antenna using the directional antenna device.

### Description of the Related Art

In general wireless communication (Wi-Fi) usage scenarios, there are obstacles such as thick walls, corners, or metals on paths from signals to user devices, resulting in Wi-Fi dead spots in specific areas. In addition, nowadays, Wi-Fi communication requires higher data transmission rates, and therefore higher frequencies are used, but high-frequency signals are more likely to be attenuated by environmental impact, and dead spots are more likely to occur.

In the existing methods, to increase the antenna gain, there are two common methods. The first method is to design antennas in an array, place the same antennas at an appropriate spacing, and control the inputted energy and phase, to achieve the effect of increasing the antenna gain. The other method is to choose a different antenna design, such as a helical antenna (omnidirectional high gain) or a patch antenna (directional high gain). However, regardless of the method, the designed antennas are bulky and do not meet the current design requirements of being thin and short in the face of the bandwidth requirements of Wi-Fi.

### BRIEF SUMMARY OF THE INVENTION

The disclosure provides a directional antenna device, including a dielectric substrate, an antenna body, a first metal element, and a second metal element. The antenna body is located on the dielectric substrate. The first metal element is located on the dielectric substrate and on one side of the antenna body. The first metal element is in a direction opposite to a radiation direction and has a first length. The second metal element is located on the dielectric substrate and on an other side of the antenna body. The second metal element is in the same direction as the radiation direction and has a second length, and the second length is less than the first length.

The disclosure further provides a directional antenna device, including a dielectric substrate, an antenna body, a first metal element, and a second metal element. The antenna body is located on the dielectric substrate. The first metal element is located on the dielectric substrate and on one side of the antenna body. The first metal element includes a first metal segment, a second metal segment, a first extension segment, and a first switch element. The first extension segment laterally connects the first metal segment and the second metal segment. The first switch element is connected to the first metal segment and the second metal segment to selectively switch a first transmission path of the first metal element to a first length or a second length, and the second length is less than the first length. The second metal element is located on the dielectric substrate and on an other side of the antenna body. The second metal element includes a third metal segment, a fourth metal segment, a second extension segment, and a second switch element. The second extension segment laterally connects the third metal segment and the fourth metal segment. The second switch element is connected to the third metal segment and the fourth metal segment to selectively switch a second transmission path of the second metal element to the second length or the first length.

The disclosure further provides an external antenna, including a base, a housing, and at least one directional antenna device. In the external antenna, the housing is connected to the base, to adjust a position of the housing on the base. The at least one directional antenna device is disposed in the housing.

Based on the above, the disclosure is a directional antenna device. The directional antenna device has a higher antenna gain in a specific direction than the general omnidirectional antenna, and therefore improves the communication quality when the environment is poor, to achieve the effect of increasing the data transmission rate and reducing the communication delay. Therefore, the disclosure uses metal elements to adjust the radiation direction of the antenna, making the antenna a directional antenna, to provide high gain and miniaturized antenna design at the same time, and effectively reduce the size of the antenna. Moreover, in the disclosure, switch elements are added to switch the antenna radiation pattern to achieve the effect of high gain and high radiation coverage.

### BRIEF DESCRIPTION OF THE DRAWINGS

FIG. 1 is a schematic structural diagram of a directional antenna device according to an embodiment of the disclosure.

FIG. 2 is a schematic structural diagram of a directional antenna device according to another embodiment of the disclosure.

FIG. 3 is a schematic block diagram of a directional antenna device controlled by a control circuit according to an embodiment of the disclosure.

FIG. 4 is a schematic structural diagram of a directional antenna device according to still another embodiment of the disclosure.

FIG. 5 is a schematic structural diagram of a directional antenna device using a dual-band antenna body according to an embodiment of the disclosure.

FIG. 6 is a schematic structural diagram of a directional antenna device using a dual-band antenna body according to another embodiment of the disclosure.

FIG. 7 is a schematic structural diagram of a directional antenna device using a dual-band antenna body according to still another embodiment of the disclosure.

FIG. 8 is a schematic structural diagram of an external antenna according to an embodiment of the disclosure.

FIG. 9 is a schematic structural diagram of an external antenna according to another embodiment of the disclosure.

FIG. 10 is a schematic structural diagram of the directional antenna device of the disclosure installed in a notebook computer.

### DETAILED DESCRIPTION OF THE EMBODIMENTS

The embodiments of the disclosure are described below with reference to the accompanying drawings. In addition, some elements or structures are omitted in the drawings in the embodiments to clearly show the technical features of the disclosure. In these drawings, the same reference numerals represent the same or similar elements or circuits. It is to be understood that although the terms “first”, “second”, etc. are used herein to describe various elements, components, areas, or functions, these elements, components, areas, and/or functions are not limited by these terms. These terms are merely used to distinguish one element, component, area, or function from another element, component, area, or function.

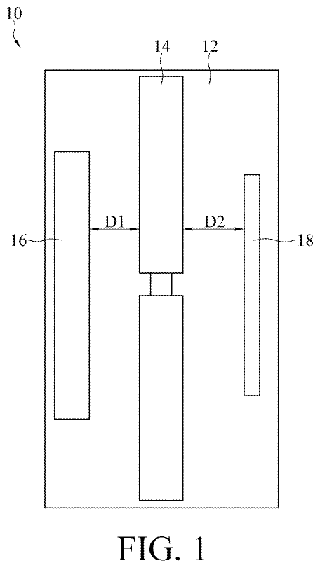

Referring to FIG. 1, a directional antenna device 10 includes a dielectric substrate 12, an antenna body 14, a first metal element 16, and a second metal element 18. In the directional antenna device 10, the antenna body 14 is located on the dielectric substrate 12 and in a central area. In this embodiment, the antenna body 14 being a single-band antenna of a dipole antenna is used as an example. The first metal element 16 is located on the dielectric substrate 12 and on one side of the antenna body 14, so that the first metal element 16 and the antenna body 14 maintain a first spacing D1. The first metal element 16 is in a direction opposite to a preset radiation direction and has a first length. The second metal element 18 is located on the dielectric substrate 12 and on an other side of the antenna body 14, so that the second metal element 18 and the antenna body 14 maintain a second spacing D2. The second metal element 18 is in the same direction as the radiation direction and has a second length, and the second length is less than the first length. Because the first metal element 16 has the longer first length, and the first metal element 16 is inductive, the first metal element 16 serves as a reflector to make the radiation direction of the antenna body 14 more focused or directed to a specific area. Because the second metal element 18 has the shorter second length, and the second metal element 18 is capacitive, the second metal element 18 serves as a director to ensure that signals are transmitted in a specific direction, to achieve the effect of the directional antenna device 10 through the functions of the reflector of the first metal element 16, the antenna body 14, and the director of the second metal element 18, so that the directional antenna device 10 receives and transmits wireless signals in a specific radiation direction. Therefore, in the disclosure, the positions of the first metal element 16 and the second metal element 18 are configured according to the specific radiation direction, and the lengths of the first metal element 16 and the second metal element 18 are adjusted according to a predetermined operating frequency of the antenna.

In an embodiment, the first spacing D1 and the second spacing D2 are in a length of 0.05 times to 0.5 times a wavelength of the operating frequency. The first length is a length greater than 0.5 times the wavelength of the operating frequency, and the second length is a length less than 0.5 times the wavelength of the operating frequency.

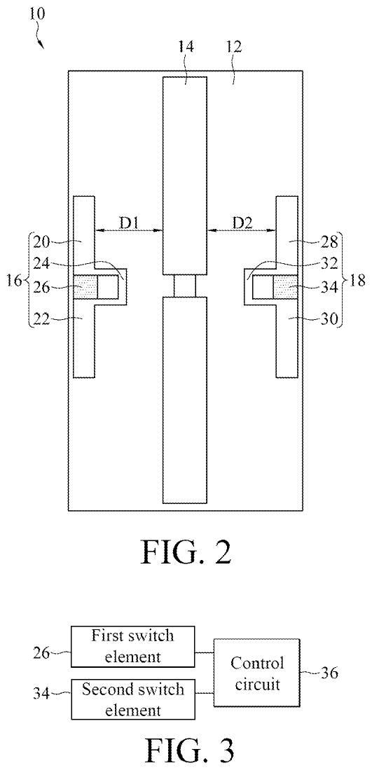

In an embodiment, referring to FIG. 2, a directional antenna device 10 includes a dielectric substrate 12, an antenna body 14, a first metal element 16, and a second metal element 18. In the directional antenna device 10, the antenna body 14 of a single-band antenna is located on the dielectric substrate 12 and in a central area. The first metal element 16 is located on the dielectric substrate 12 and on one side of the antenna body 14, so that is the first metal element 16 and the antenna body 14 maintain a first distance D1. The first metal element 16 includes a first metal segment 20, a second metal segment 22, a first extension segment 24, and a first switch element 26. The first extension segment 24 laterally connects two adjacent ends of the first metal segment 20 and the second metal segment 22, and two ends of the first switch element 26 are respectively connected to the adjacent ends of the first metal segment 20 and the second metal segment 22, to selectively switch a first transmission path of the first metal element 16 through the first switch element 26 to a first length formed by the first metal segment 20, the first extension segment 24, and the second metal segment 22, or a second length formed by the first metal segment 20, the first switch element 26, and the second metal segment 22, where the second length is less than the first length. The second metal element 18 is located on the dielectric substrate 12 and on an other side of the antenna body 14, to correspond to the first metal element 16, so that the second metal element 18 and the antenna body 14 maintain a second spacing D2. The second metal element 18 includes a third metal segment 28, a fourth metal segment 30, a second extension segment 32, and a second switch element 34. The second extension segment 32 laterally connects two adjacent ends of the third metal segment 28 and the fourth metal segment 30, and two ends of the second switch element 34 are respectively connected to the adjacent ends of the third metal segment 28 and the fourth metal segment 30, to selectively switch a second transmission path of the second metal segment 18 through the second switch element 34 to a second length formed by the third metal segment 28, the second switch element 34, and the fourth metal segment 30, or a first length formed by the third metal segment 28, the second extension segment 32, and the fourth metal segment 30. The first spacing DI is equal to the second spacing D2, and a length of the first metal element 16 is equal to a length of the second metal element 18.

Referring to FIG. 2 and FIG. 3 together, in the directional antenna device 10, in the disclosure, a control circuit 36 is used to electrically connect the first switch element 26 and the second switch element 34 to control ON/OFF of the first switch element 26 to determine the length of the first metal element 16, and control ON/OFF of the second switch element 34 to determine the length of the second metal element 18, so that the first metal element 16 and the second metal element 18 have different lengths respectively. When the control circuit 36 transmits a control signal to control the ON state of the first switch element 26, the first transmission path of the first metal element 16 is switched to the shorter second length formed by the first metal segment 20, the first switch element 26, and the second metal segment 22. In this case, the second switch element 34 maintains the OFF state, and the second transmission path of the second metal element 18 is switched to the longer first length formed by the third metal segment 28, the second extension segment 32, and the fourth metal segment 30. Because the first metal element 16 has the shorter second length, the first metal element 16 serves as a director. Because the second metal element 18 has the longer first length, the second metal element 18 serves as a reflector, to achieve the effect of the directional antenna device 10 through the functions of the director of the first metal element 16, the antenna body 14, and the reflector of the second metal element 18, so that the directional antenna device 10 receives and transmits wireless signals in a specific radiation direction. When the control circuit 36 transmits a control signal to control the ON state of the second switch element 34, the second transmission path of the second metal element 18 is switched to the shorter second length formed by the third metal segment 28, the second switch element 34, and the fourth metal segment 30; In this case, the first switch element 26 is switched to the OFF state, and the first transmission path of the first metal element 16 is switched to the longer first length formed by the first metal segment 20, the first extension segment 24, and the second metal segment 22. Because the first metal element 16 has the longer first length, the first metal element 16 serves as a reflector. Because the second metal element 18 has the shorter second length, the second metal element 18 serves as a director, to achieve the effect of the directional antenna device 10 through the functions of the reflector of the first metal element 16, the antenna body 14, and the director of the second metal element 18, so that the directional antenna device 10 receives and transmits wireless signals in another specific radiation direction.

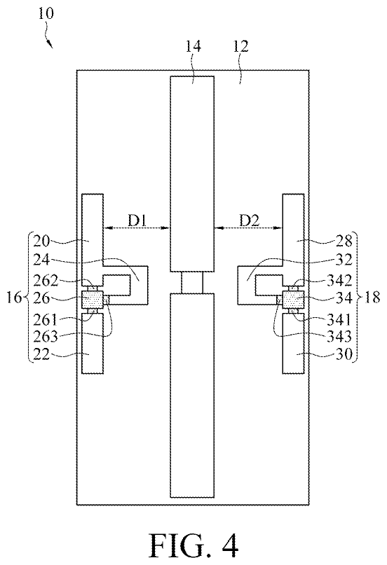

In another embodiment, the first switch element 26 and the second switch element 34 of the disclosure use a one-to-two switch in addition to a general on-off switch. Referring to FIG. 4, a directional antenna device 10 includes a dielectric substrate 12, an antenna body 14, a first metal element 16, and a second metal element 18. In the directional antenna device 10, the antenna body 14 of a single-band antenna is located on the dielectric substrate 12 and in a central area. The first metal element 16 is located on the dielectric substrate 12 and on one side of the antenna body 14, so that the first metal element 16 and the antenna body 14 maintain a first spacing D1. The first metal element 16 includes a first metal segment 20, a second metal segment 22, a first extension segment 24, and a first switch element 26. One end of the first extension segment 24 is connected to the end of the first metal segment 20, and the other end of the first extension segment 24 is connected to the switching end 263 of the first switch element 26. The first switch element 26 is arranged between the first metal segment 20 and the second metal segment 22, one fixed end 261 of the first switch element 26 is connected to the second metal segment 22, and the two switching ends 262, 263 of the first switch element 26 are respectively connected to the end of the first metal segment 20 and the first extension segment 24, so that the first extension segment 24 is connected to the second metal segment 22 through the first switch element 26, so that the first transmission path of the first metal element 16 is selectively switched by the first switch element 26. A first length formed by the second metal segment 22 or a second length formed by the first metal segment 20, the first switch element 26 and the second metal segment 22. The second metal element 18 is located on the dielectric substrate 12 and on the other side of the antenna body 14 to correspond to the first metal element 16, so that the second spacing D2 is maintained between the second metal element 18 and the antenna body 14. The second metal element 18 includes a third metal segment 28, a fourth metal segment 30, a second extension segment 32, and a second switch element 34. One end of the second extension segment 32 is laterally connected to a tail end of the third metal segment 28, and the other end of the second extension segment 32 is connected to a switching end 343 of the second switch element 34. The second switch element 34 is disposed between the third metal segment 28 and the fourth metal segment 30, a fixed end 341 of the second switch element 34 is connected to the fourth metal segment 30, and two switching ends 342 and 343 of the second switch element 34 are respectively connected to the tail end of the third metal segment 28 and the second extension segment 32, so that the second extension segment 32 is connected to the fourth metal segment 30 through the second switch element 34, to selectively switch a second transmission path of the second metal element 18 through the second switch element 34 to a second length formed by the third metal segment 28, the second switch element 34, and the fourth metal segment 30, or a first length formed by the third metal segment 28, the second extension segment 32, the second switch element 34, and the fourth metal segment 30.

Referring to FIG. 3 and FIG. 4 together, in the directional antenna device 10, in the disclosure, a control circuit 36 is also used to electrically connect the first switch element 26 and the second switch element 34 to control the switching path of the first switch element 26 to determine the length of the first metal element 16, and control the switching path of the second switch element 34 to determine the length of the second metal element 18, so that the first metal element 16 and the second metal element 18 have different lengths respectively. Specifically, when the control circuit 36 transmits a control signal to control the first switch element 26 to turn on the first metal segment 20 and the second metal segment 22, the first transmission path of the first metal element 16 is switched to the shorter second length formed by the first metal segment 20, the first switch element 26, and the second metal segment 22; In this case, when the control circuit 36 transmits another control signal to control the second switch element 34 to turn on the second extension segment 32 and the fourth metal segment 30, the second transmission path of the second metal element 18 is switched to the longer first length formed by the third metal segment 28, the second extension segment 32, the second switch element 34, and the fourth metal segment 30. Because the first metal element 16 has the shorter second length, the first metal element 16 serves as a director. Because the second metal element 18 has the longer first length, the second metal element 18 serves as a reflector, to achieve the effect of the directional antenna device 10 through the functions of the director of the first metal element 16, the antenna body 14, and the reflector of the second metal element 18, so that the directional antenna device 10 receives and transmits wireless signals in a specific radiation direction. When the control circuit 36 transmits a control signal to control the second switch element 34 to turn on the third metal segment 28 and the fourth metal segment 30, the second transmission path of the second metal element 18 is switched to the shorter second length formed by the third metal segment 28, the second switch element 34, and the fourth metal segment 30. In this case, when the control circuit 36 transmits another control signal to control the first switch element 26 to turn on the first extension segment 24 and the second metal segment 22, the first transmission path of the first metal element 16 is switched to the longer first length formed by the first metal segment 20, the first extension segment 24, the first switch element 26, and the second metal segment 22. Because the first metal element 16 has the longer first length, the first metal element 16 serves as a reflector. Because the second metal element 18 has the shorter second length, the second metal element 18 serves as a director, to achieve the effect of the directional antenna device 10 through the functions of the reflector of the first metal element 16, the antenna body 14, and the director of the second metal element 18, so that the directional antenna device 10 receives and transmits wireless signals in another specific radiation direction.

In an embodiment, the control circuit 36 for controlling the operation of the first switch element 26 and the second switch element 34 is, but not limited to, a central processing unit (CPU), an embedded controller (EC), a microprocessor, a digital signal processor (DSP), an application-specific integrated circuit (ASIC), a system on a chip (SOC), or other similar elements or combinations.

In an embodiment, as shown in FIG. 2 and FIG. 3, in the directional antenna device 10, the first extension segment 24 used in the first metal element 16 and the second extension segment 32 used in the second metal element 18 are a [symbol] -shaped metal bending structures. Any shape that extends the length of the first metal element 16 and the second metal element 18 is applicable.

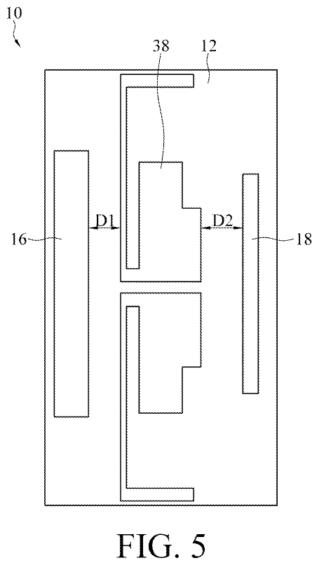

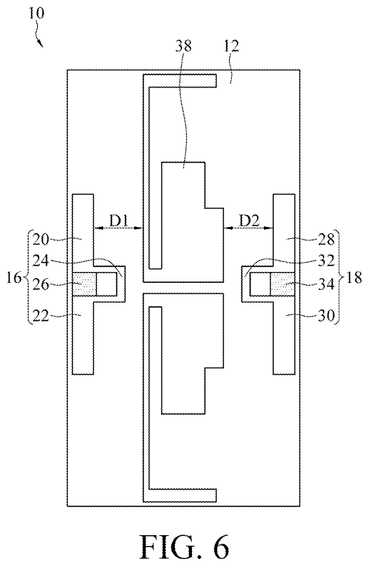

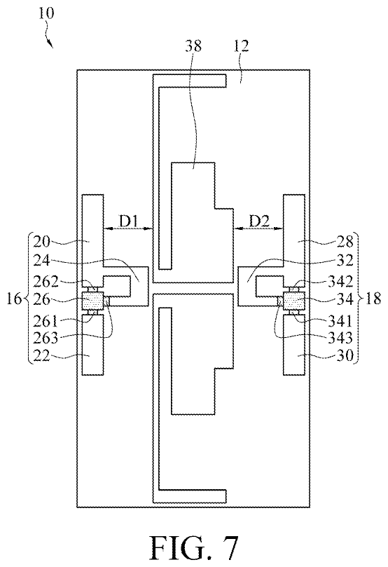

In the foregoing embodiments, the directional antenna device 10 uses a single-band antenna as the antenna body 14. In addition, a dual-band antenna is also used as the antenna body 14 in the disclosure. Referring to FIG. 5, FIG. 6, and FIG. 7 together, a directional antenna device 10 includes a dielectric substrate 12, a dual-band antenna body 38, a first metal element 16, and a second metal element 18. The dual-band antenna body 38 includes an antenna unit that supports both high band and low band. Except for using the different dual-band antenna body 38, the directional antenna device 10 has the same element structure, connection relationship and actuation as the foregoing embodiments. Therefore, reference is made to the foregoing detailed description, and no details are provided herein.

In an embodiment, as shown in FIG. 1 and FIG. 5, the antenna body 14, the dual-band antenna body 38, the first metal element 16, and the second metal element 18, and, as shown in FIG. 2, FIG. 4, FIG. 6, and FIG. 7, the antenna body 14, the dual-band antenna body 38, the first metal segment 20, the second metal segment 22, the first extension segment 24, the third metal segment 28, the fourth metal segment 30, and the second extension segment 32, are made of conductive metal materials, such as silver, copper, aluminum, iron, or alloys thereof.

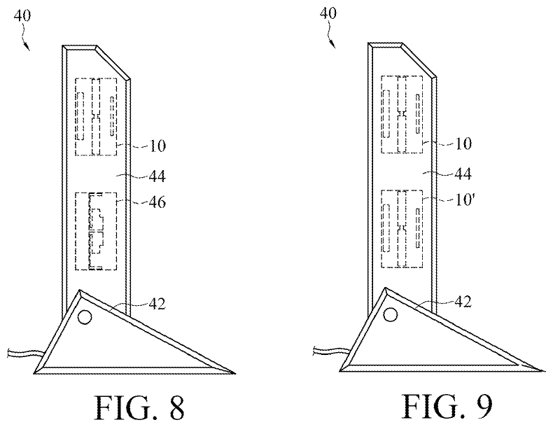

Referring to FIG. 8, an external antenna 40 includes a base 42, a housing 44, at least one directional antenna device 10, and an omnidirectional antenna device 46. In the external antenna 40, the housing 44 is connected to the base 42. Axial connection is used as an example herein. The housing 44 is axially connected to the base 42, so that the position (orientation) of the housing 44 is adjusted on the base 42. The directional antenna device 10 and the omnidirectional antenna device 46 are disposed in the housing 44. The directional antenna device 10 is any structural design shown in FIG. 1, FIG. 2, and FIG. 4 to FIG. 7. In the disclosure, the directional antenna device 10 and the omnidirectional antenna device 46 are disposed inside the housing 44 of the external antenna 40, to receive and transmit wireless signals through the directional antenna device 10 and the omnidirectional antenna device 46, thereby achieving better performance and wider band response.

Referring to FIG. 9, an external antenna 40 includes a base 42, a housing 44, and two-directional antenna devices 10 and 10′. In the external antenna 40, the housing 44 is connected to the base 42. Axial connection is used as an example herein. The housing 44 is axially connected to the base 42, so that the position (orientation) of the housing 44 is adjusted on the base 42, and the directional antenna devices 10 and 10′ are disposed in the housing 44. The directional antenna devices 10 and 10′ are any two structural designs shown in FIG. 1, FIG. 2, and FIG. 4 to FIG. 7. Two directional antenna devices 10 and 10′ are disposed inside the housing 44, to receive and transmit wireless signals in different specific directions or specific areas through the directional antenna devices 10 and 10′, to improve the communication quality when the environment is poor.

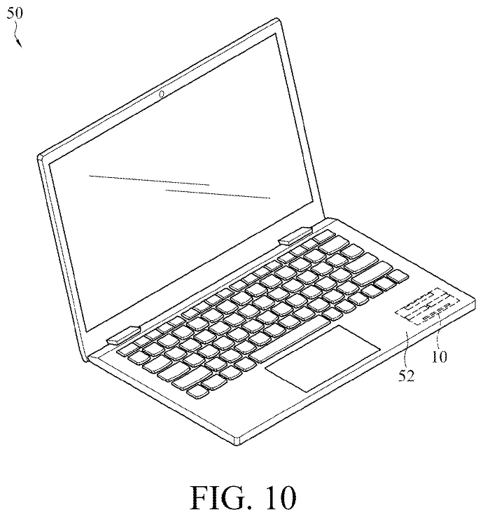

The directional antenna device 10 of the disclosure is directly installed in an electronic device. In an embodiment, the electronic device is a notebook computer 50. Referring to FIG. 10, the directional antenna device 10 is directly installed inside a housing 52 of the notebook computer 50, to receive and transmit wireless signals through the directional antenna device 10.

Based on the above, the disclosure is a directional antenna device. The directional antenna device has a higher antenna gain in a specific direction than the general omnidirectional antenna, and therefore improves the communication quality when the environment is poor, to achieve the effect of increasing the data transmission rate and reducing the communication delay. Therefore, the disclosure uses metal elements to adjust the radiation direction of the antenna, making the antenna a directional antenna, to provide high gain and miniaturized antenna design at the same time, and effectively reduce the size of the antenna to ⅕ to 1/10. Moreover, in the disclosure, switch elements are added to switch the radiation pattern of the antenna, to achieve the effect of high gain and high radiation coverage, and to make up for the weak back radiation of the directional antenna.

The above embodiments are merely to describe the technical ideas and characteristics of the disclosure to enable a person skilled in the art to understand the content of the disclosure and implement it accordingly, and are not used to limit the scope of the claims of the disclosure. That is, any equivalent change or modification made according to the spirit disclosed in the disclosure still falls within the scope of the claims of the disclosure.

What is claimed is:

1. A directional antenna device, comprising:
a dielectric substrate;
an antenna body, located on the dielectric substrate;
a first metal element, located on the dielectric substrate and on one side of the antenna body, wherein the first metal element is in a direction opposite to a radiation direction and has a first length; and
a second metal element, located on the dielectric substrate and on an other side of the antenna body, wherein the second metal element is in the same direction as the radiation direction, and has a second length, and the second length is less than the first length.

2. The directional antenna device according to claim 1, wherein the first metal element and the antenna body maintain a first spacing, the second metal element and the antenna body maintain a second spacing, and the first spacing and the second spacing are in a length of 0.05 times to 0.5 times a wavelength of an operating frequency.

3. The directional antenna device according to claim 1, wherein the first length is greater than a length of 0.5 times a wavelength of an operating frequency.

4. The directional antenna device according to claim 1, wherein the second length is less than a length of 0.5 times a wavelength of an operating frequency.

5. The directional antenna device according to claim 1, wherein the antenna body is a single-band antenna or a dual-band antenna.

6. The directional antenna device according to claim 1, installed in an electronic device.

7. The directional antenna device according to claim 1, installed in an external antenna.

8. The directional antenna device according to claim 7, wherein an omnidirectional antenna device is further disposed in the external antenna.

9. A directional antenna device, comprising:
a dielectric substrate;
an antenna body, located on the dielectric substrate;
a first metal element, located on the dielectric substrate and on one side of the antenna body, wherein the first metal element comprises:
a first metal segment;
a second metal segment;
a first extension segment, laterally connecting the first metal segment and the second metal segment; and
a first switch element connected to the first metal segment and the second metal segment to selectively switch a first transmission path of the first metal element to a first length or a second length, wherein the second length is less than the first length; and
a second metal element, located on the dielectric substrate and on an other side of the antenna body, wherein the second metal element comprises:
a third metal segment;
a fourth metal segment;
a second extension segment, laterally connecting the third metal segment and the fourth metal segment; and
a second switch element, connected to the third metal segment and the fourth metal segment to selectively switch a second transmission path of the second metal element to the second length or the first length.

10. The directional antenna device according to claim 9, wherein the first metal element and the antenna body maintain a first spacing, the second metal element and the antenna body maintain a second spacing, and the first spacing is equal to the second spacing.

11. The directional antenna device according to claim 10, wherein the first spacing and the second spacing are in a length of 0.05 times to 0.5 times a wavelength of an operating frequency.

12. The directional antenna device according to claim 9, wherein the first length is greater than a length of 0.5 times a wavelength of an operating frequency.

13. The directional antenna device according to claim 9, wherein the second length is less than a length of 0.5 times a wavelength of an operating frequency.

14. The directional antenna device according to claim 9, wherein the antenna body is a single-band antenna or a dual-band antenna.

15. The directional antenna device according to claim 9, wherein the first switch element is further connected to the first metal segment, the second metal segment, and the first extension segment at the same time, and the first extension segment is connected to the second metal segment through the first switch element, to selectively switch the first transmission path of the first metal element to the first length formed by the first metal segment, the first extension segment, the first switch element, and the second metal segment, or the second length formed by the first metal segment, the first switch element, and the second metal segment; and the second switch element is further connected to the first metal segment, the second metal segment, and the second extension segment at the same time, and the second extension segment is connected to the fourth metal segment through the second switch element, to selectively switch the second transmission path of the second metal element to the second length formed by the third metal segment, the second switch element, and the fourth metal segment, or the first length formed by the third metal segment, the second extension segment, the second switch element, and the fourth metal segment.

16. The directional antenna device according to claim 9, wherein the directional antenna device is installed in an electronic device.

17. The directional antenna device according to claim 9, wherein the directional antenna device is installed in an external antenna.

18. The directional antenna device according to claim 17, wherein an omnidirectional antenna device is further disposed in the external antenna.

19. An external antenna, comprising:
a base;
a housing, connected to the base to adjust a position of the housing on the base; and
at least one directional antenna device, located in the housing, wherein the directional antenna device comprises:
a dielectric substrate;
an antenna body, located on the dielectric substrate;
a first metal element, located on the dielectric substrate and on one side of the antenna body, wherein the first metal element is in a direction opposite to a radiation direction and has a first length; and
a second metal element, located on the dielectric substrate and on an other side of the antenna body, wherein the second metal element is in the same direction as the radiation direction and has a second length, and the second length is less than the first length.

20. The external antenna according to claim 19, further comprising an omnidirectional antenna device, located in the housing.

21. An external antenna, comprising:
a base;
a housing, connected to the base to adjust a position of the housing on the base; and
at least one directional antenna device, located in the housing, wherein the directional antenna device comprises:
a dielectric substrate;
an antenna body, located on the dielectric substrate;
a first metal element, located on the dielectric substrate and on one side of the antenna body, wherein the first metal element comprises: a first metal segment; a second metal segment; a first extension segment, laterally connecting the first metal segment and the second metal segment; and a first switch element, connected to the first metal segment and the second metal segment to selectively switch a first transmission path of the first metal element to a first length or a second length, wherein the second length is less than the first length; and
a second metal element, located on the dielectric substrate and on an other side of the antenna body, wherein the second metal element comprises: a third metal segment; a fourth metal segment; a second extension segment, laterally connecting the third metal segment and the fourth metal segment; and a second switch element, connected to the third metal segment and the fourth metal segment to selectively switch a second transmission path of the second metal element to the second length or the first length.

22. The external antenna according to claim 21, further comprising an omnidirectional antenna device, located in the housing.
